(19) United States
(12) Patent Application Publication
(10) Pub. No.: US 2005/0055625 A1
(43) Pub. Date: Mar. 10, 2005

(54) Timeline publishing system

(76) Inventor: Ronald J. Kloss, Lake Forest, CA (US)

Correspondence Address: STETINA BRUNDA GARRED & BRUCKER, 75 ENTERPRISE, SUITE 250, ALISO VIEJO, CA, 92656, US

(21) Appl. No.: 10/970,616

(22) Filed: Oct. 21, 2004

Related U.S. Application Data
(63) Continuation of application No. 09/680,015, filed on Oct. 5, 2000, now abandoned.

(51) Int. Cl. G06F 17/00

(52) U.S. Cl. 715/500.1

(57) ABSTRACT

The present invention generally relates to a software system for publishing graphical items and more particularly to a software system operative to create timelines that may be displayed on a computer. The software system includes a data entry section operative to receive a starting date and a finishing date for an event from the user of the system. In communication with the data entry section is a time box creating section operative to create a time box displayable on the computer. The time box created by the software system corresponds to the period of time between the starting date and the ending date entered by the user with the data entry section and may include a photo and/or image depicting the event. Finally, the software system further includes a linking section operative to link the time box to an event page. The event page comprises information corresponding to the event having the starting date and finishing date entered by the user into the data entry section. Accordingly, the timeline publishing software system of the present invention is operative to create an interactive timeline displayable upon a computer.

### CROSS-REFERENCE TO RELATED APPLICATIONS

Not Applicable

### STATEMENT RE: FEDERALLY SPONSORED RESEARCH/DEVELOPMENT

(Not Applicable)

### BACKGROUND OF THE INVENTION

The present invention generally relates to a software system for creating timelines and more particularly to a software system operative to create timelines that may be displayed on a computer and are interactive.

Computers are capable of displaying multimedia presentations to users. The presentations may include images, text, audio, and/or video. In this respect, the computer is operative to present a multimedia experience on the computer's display to the user.

Often times, a user will wish to create his or her own multimedia presentation. Presentation software has been developed to allow a user to create multimedia presentations with a computer. The presentation software allows the user to create a presentation having pictures, graphics, text and audio that will be displayed by the computer. In this respect, the presentation software allows users to create content rich presentations very quickly and easily. Typically, the presentation software is non-interactive such that the information must be presented in a predetermined order. Accordingly, the viewer has no control over the order and type of information that is to be presented. Recently, web authoring software has become available for creating web pages. However, such software does not allow the user to easily create interactive presentations showing temporal relationships between events. Digital scrapbook software allows a user to store pictures, portions of pictures and images on his or her computer and retrieve the same. However, digital scrapbook software does not provide a system or means for easily displaying such images in a temporal sequence, or linking such photographs to other images.

Project management software creates charts regarding the timing of events for planning a task (i.e., a construction or product development or project). In this respect, the project management software creates a horizontal timeline which displays timing information. Charting software similarly creates a graphic representation of time for planning tasks and events. However, neither of these types of software packages allows the user to create an interactive graphical display which can show temporal relationships and information quickly and easily.

A timeline is typically used to display a series of dates of events that have occurred. Typically, the timeline is a horizontal line depicting the occurrence of time over a prescribed period (i.e., years, days, hours, etc.) Vertical hash marks are placed on the horizontal timeline to indicate the date an event has occurred. Usually, the date of the event, as well as a short description of the event, is placed next to the corresponding vertical hash mark. In this manner, the date and type of event may be presented to viewers.

If a computer user wishes to create a timeline on a computer, the user must use existing software packages (i.e., presentation software) adapted to create multimedia presentations. Specifically, the prior art systems are capable of creating content rich presentations but not in the form of a timeline. Accordingly, a user may have to adapt the prior art software system to create content rich timelines that are displayable on the computer.

The present invention addresses the above-mentioned deficiencies of the prior art systems by providing a software publishing system that specifically creates content rich timelines. The present invention is capable of creating a timeline which can present video, audio and images to a user. Specifically, the present invention provides a timeline publishing software system whereby a user can create content rich presentations which are linked to the timeline created by the user. In this respect, the timeline publishing system of the present invention creates timelines that can be used by individuals and businesses. Additionally, the timeline publishing system of the present invention creates timelines that can be explored interactively depending on the viewers' interest and in any order, which is unlike presentation software which creates a predetermined linear presentation.

### BRIEF SUMMARY OF THE INVENTION

In accordance with the present invention there is provided a method of forming an interactive timeline using a computer. The method comprises entering a starting date for an event into the computer. Next, an ending date for the event is entered into the computer. A time box is created by the computer corresponding to a period of time between the starting date and the ending date. Finally, the time box is linked to an event page wherein the event page comprises information that occurred during the period of time between the starting date and the ending date for the event.

In the preferred embodiment, the time box, as well as the event page, are presented on a display of the computer. Typically, the time box will be labeled on the display of the computer with the name of the event that the time box is linked therewith. The time box may be displayed vertically on the display of the computer in order to facilitate viewing and scrolling thereof. Multiple time boxes will be displayed vertically on the screen of the computer in order to form a timeline. In this respect, a series of time boxes will be a timeline which the user can view. Disposed within each time box may be a miniature photograph depicting the event of the time box. The miniature photograph is imported from a data file created for this purpose.

The event page is created using the timeline publishing software system of the present invention. The event page comprises images, text, and/or audio corresponding to the event. Typically, the event page is created prior to linking the time box therewith.

In the preferred embodiment of the present invention, multiple time boxes may be created and linked to respective event pages. In this respect, the timeline publishing software system of the present invention is adapted to create a time box for each event entered by the user. Each of the time boxes is then linked to a respective one of the event pages. Accordingly, the event page linked to a corresponding time box will comprise only information regarding the event specific to the time box. A miniature photograph depicting the event may be placed within each of the time boxes.

Alternatively, a single time box may be created to correspond to multiple events. Accordingly, the time box will correspond to multiple events that occurred during the period of time between a starting date for the first event and an ending date for the last event. The event page may comprise information corresponding to the multiple events that occurred during the period of time between the starting date of the first event and the ending date of the last event.

In accordance with the present invention there is provided a timeline publishing software system for a computer. The timeline publishing software system comprises a date entry section operative to receive a starting date and a finishing date for an event. Additionally, the timeline publishing software system includes a time box creating section which is operative to create a time box that is displayable on the computer. The time box corresponds to the period of time between the starting date and the ending date for the event. A linking section is operative to link the time box to an event page. The event page comprises information corresponding to the event which occurred between the starting date and the finishing date of the time box created with the date entry section. In this respect, the timeline publishing software system is operative to create a timeline comprising multiple time boxes displayed vertically on the computer screen. The user can interact with the time boxes of the timeline in order to receive information regarding the events occurring during the period of time depicted on the timeline.

The timeline publishing software system of the present invention may further include an event page creation section which is operative to create the event page prior to linking the time box therewith. The event page creation section creates a display presentable on the display of the computer which presents content-rich information to the user corresponding to the event. In the preferred embodiment of the present invention, the data entry section may be operative to receive a respective starting and finishing date for multiple events. The time box creating section would be operative to create multiple time boxes corresponding to respective ones of the multiple events. Additionally, the linking section would be operative to link respective ones of the time boxes to a respective event page comprising information corresponding only to that event. Furthermore, the timeline publishing software system of the present invention may further include a labeling section which is operative to label the time box prior to linking the same to the event page.

### BRIEF DESCRIPTION OF THE DRAWINGS

These as well as other features of the present invention will become more apparent upon reference to the drawings wherein:

FIG. 1 is a flow chart depicting the series of events used to create a timeline in accordance with the present invention;

FIG. 2 is a block level diagram showing system sections of the timeline publishing software system of the present invention;

FIG. 3 is a representation of a screen shot presented on a display of a computer and showing a timeline created in accordance with the present invention;

FIG. 4 is a screen shot depicting an event page created in accordance with the present invention;

FIG. 5 is a screen shot depicting a time box entry screen; and

FIG. 6 is a screen shot depicting a calendar page created in accordance with the present invention.

### DETAILED DESCRIPTION OF THE INVENTION

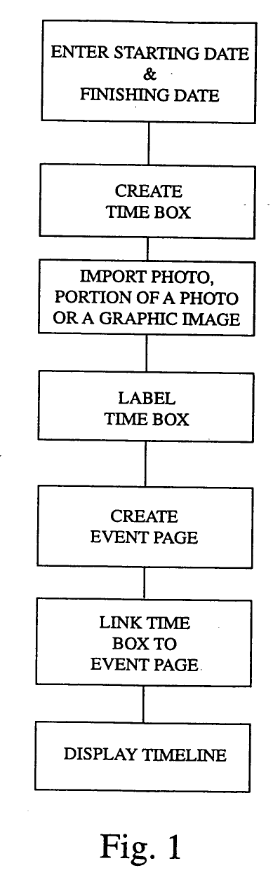

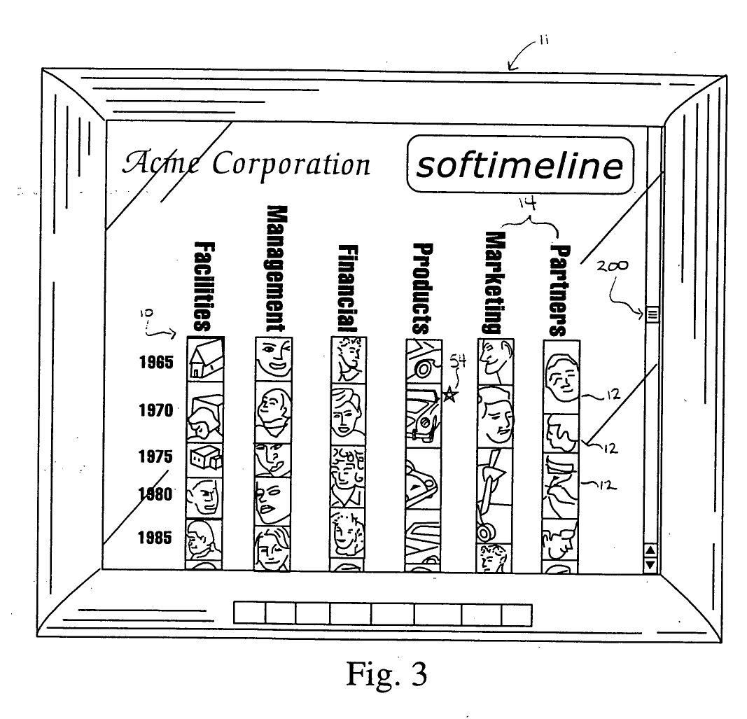

Referring now to the drawings wherein the showings are for purposes of illustrating a preferred embodiment of the present invention only and not for purposes of limiting the same, FIG. 1 is a flow chart depicting the series of events necessary to create an interactive timeline 10 shown in FIG. 3. Specifically, the timeline 10, is presented upon a computer display 11 and is interactive with a user. Referring to FIG. 3, the timeline 10 comprises a series of time boxes 12 located vertically on the display 111 of the computer. Each of the time boxes 12 is disposed beneath a respective label 14 which corresponds to a category chosen by the creator of the timeline 10, as will be further explained below. Each of the time boxes 12 begin at a different period of time and the length of each time box 12 may correspond to a prescribed period of time selected by the creator. By way of example only and not limitation, a time box 12 may begin in the year 1965 and extend until the year 1985. In this respect, the time box 12 will correspond to events (i.e., important corporate events) that have occurred within that period of time. Disposed within each time box 12 may be a photograph, portion of a photograph or graphic image which depicts the events of each time box 12. The photograph, portion of a photograph or graphic image is imported into the timeline 10, as will be explained below.

As previously mentioned, each of the time boxes 12 is displayed in a vertical orientation, as seen in FIG. 3. The vertical orientation of each time box 12 allows the timeline 10 to be scrolled upwardly or downwardly on the display 111 of the computer with scroll bar 200. This is especially useful if the timeline 10 is incorporated into a web page because users are accustomed to scrolling vertically. Accordingly, a series of vertically oriented time boxes 12 create a period of time corresponding from a first time box 12 to a last time box 12. The series of time boxes 12 create and define a vertical timeline, as will be recognized by those of ordinary skill in the art.

As previously mentioned, each of the time boxes 12 is located under a label 14 corresponding to a prescribed category. For instance, if the timeline 10 is a corporate history, then each of the labels 14 may be associated with certain events occurring during the life of the corporation. Examples of such categories are financial, marketing, partners, facilities, etc. The categories may be selected by the creator of the timeline 10 in order to emphasize specific events that have occurred during the period of time that the timeline 10 depicts. As seen in FIG. 3, each of the labels 14 is placed vertically above a corresponding series of time boxes 12.

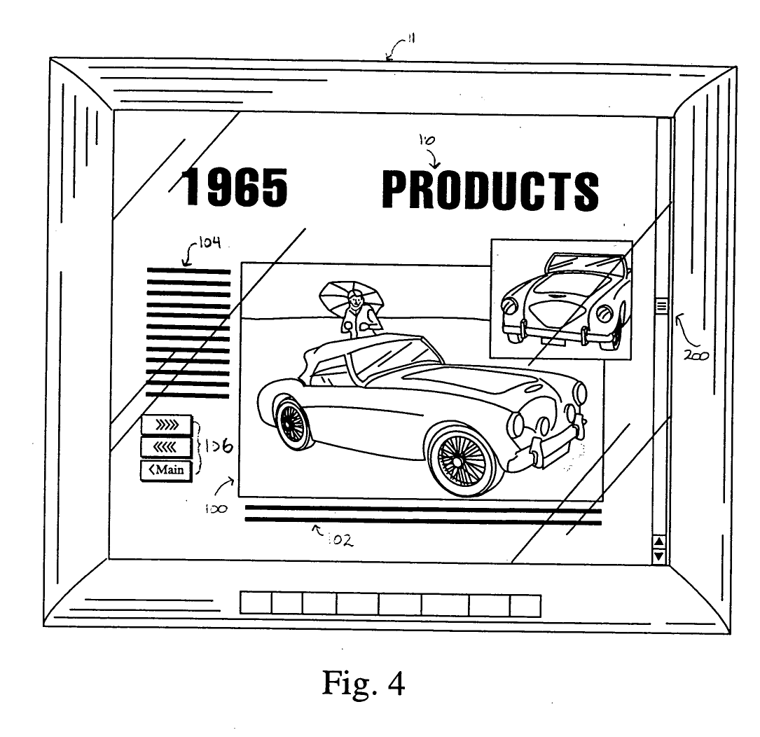

Referring to FIG. 4, an event page 16 is linked to each of the time boxes 12 and may be presented on computer display 11. In this respect, if a viewer of the timeline 10 selects a time box 12 with a computer pointing device (i.e., mouse), the event page 16 corresponding to the time box 12 will be displayed. The event page 16 comprises information regarding the events taking place during the period of time depicted by the corresponding time box 12. The event page 16 may contain content rich information such as images 100, graphics 102, text 104, video and/or audio. Accordingly, a viewer of the event page 16 may easily understand the information presented. As will be recognized, the event page 16 may be created such that the size of the event page 16 exceeds the size of the display 111 of the computer. Accordingly, the event page 16 may be viewed using scroll bar 200 to move the event page 16 on the display 11 of the computer. The scroll bar may be vertical and/or horizontal depending upon the content of the event page 16. Furthermore, the event page 16 may include navigation button 106 which allow the user to access previous and subsequent pages and return to the timeline page 10.

As previously mentioned, the event page 16 may include images that can be viewed. Each of the images may be linked to a second event page which contains further information regarding the image being viewed. If a viewer using the timeline 10 selects an image of the event page 16 with the pointing device of the computer, the second event page will then be displayed. Similarly, an image on the first event page 16 may be linked to an audio clip which may be played if selected by the user of the timeline 10. It will be recognized that each of the images on the event page 16 may be linked to another timeline 10 which describes in more detail the events depicted by the image displayed on the event page 16. Therefore, the timeline 10 created in accordance with the present invention, may be interactive with the viewer because the viewer may select different images and/or time boxes 12 in order to access different events of the timeline 10.

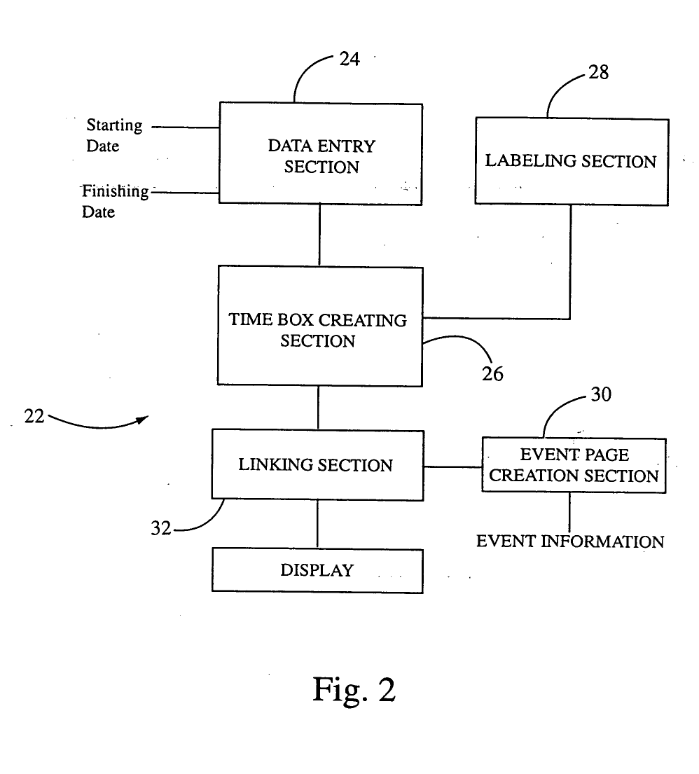

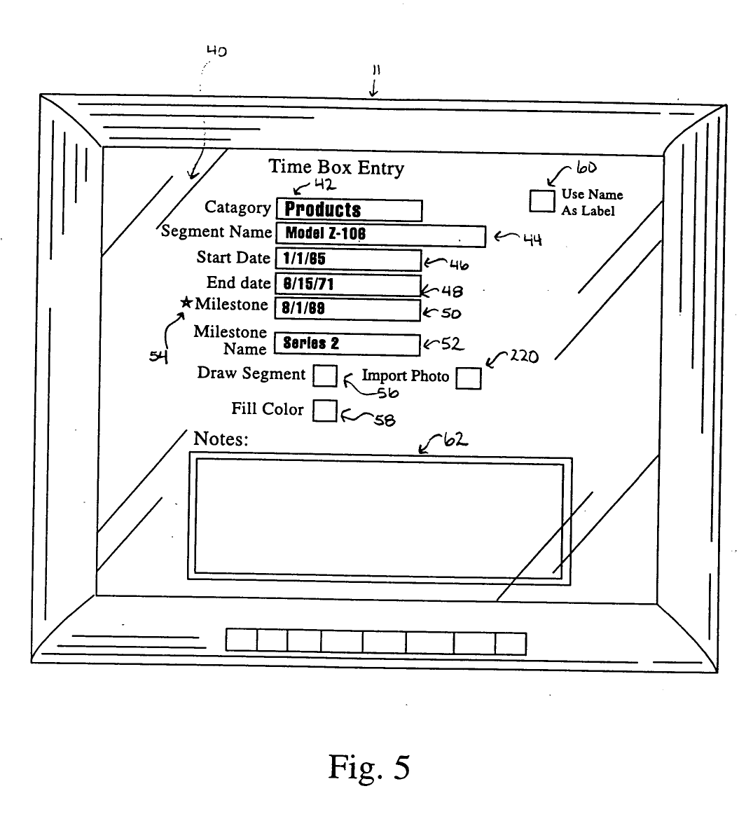

Referring to FIG. 1, the timeline 10 is created by the timeline publishing software system 22 shown in FIG. 2. In FIG. 5, the timeline 10 is created by first entering a starting date and finishing date for an event into a time box entry display 40 of data entry section 24 of the software system 22. The time box entry display 40 is presented on the display 11 of the computer. The time box entry display 40 allows the user to enter critical information about each time box 12. Accordingly, as seen in FIG. 5, the time box entry display 40 includes a section whereby the user can enter the category name 42, the segment name 44, start date 46 and end date 48. The category name 42 is the same as the label 14 which is associated with certain events occurring during the history of a corporation. The segment name 44 corresponds to the name that the creator of the timeline 10 gives to each time box 12. In this respect, the segment name 44 may describe the events occurring during the period of time that each time box 12 corresponds to. The start date 46 corresponds to the beginning of the event to be depicted by the time box 12. Correspondingly, the end date 48 corresponds to the ending of the event depicted by the time box 12.

The data entry section 24, shown in FIG. 2, is the interface between the creator of the timeline 10 and the computer upon which the timeline publishing software system 22 is installed upon. As such, the data entry section 24 may be used for other types of data-entry into the timeline publishing software system 22. For example, the time box entry display 40 may further include milestone entry 50 and milestone name 52. The milestone entry 50 allows the creator of timeline 10 to flag certain time boxes 12 that have important information. The creator of the timeline 10 will enter the date of the milestone in milestone entry 50, as well as enter the name (i.e., event) of the milestone in milestone name 52. The timeline publishing software 22 will then show that a milestone occurred on the timeline 10 by displaying the milestone indicator 50 at the corresponding date. The milestone name 52 will be used to describe the milestone such that when the viewer of timeline 10 passes his or her mouse over the milestone indicator 54, the milestone name 52 will pop-up on the display 11 at the correct position on the timeline 10.

The time box entry display 40 further includes a draw segment box 56 and a fill color box 58. The creator of the timeline 10 will select the draw segment box 56 when he/she wishes a time box 12 to be drawn on the timeline 10 corresponding to the starting date and entry date that he or she has already entered. The fill color box 58 allows the creator of the timeline 10 to choose the color of each time box 12 using a pop-up pallette of colors in order to make a more pleasing display and to further differentiate adjacent time boxes 12. The time box entry display 40 further includes a “use name as label” box 60 which allows the creator of the timeline 10 to use the segment name 44 as a pop-up label for the corresponding time box 12. Specifically, as the viewer of the timeline 10 places his or her mouse over a time box 12, if the “use name as label” box 60 is selected, then the segment name 44 will pop up on the display 11 thereby describing the corresponding time box 12. In addition to the foregoing, the time box entry display 40 will further include a notes section 62 that allows the creator of the timeline 10 to enter information regarding the time box 12. The notes section 62 may be used as notes on the corresponding event page 16 for the time box 12 created with the time box entry display 40. The time box entry display 40 includes an import photo box 220 for including a photo, a portion of a photo, or a graphic image in the time box 12. By checking the import photo box 220 the user will be able to preview photographs to choose.

Once the starting date and finishing date have been entered into the data entry section 24 with time box entry display 40, the timeline publishing software system 22 will create a corresponding time box 12, as previously described above. Specifically, the timeline publishing software system 22 includes a time box creating section 26 which creates the graphic time box 12 on the timeline 10. As previously mentioned, the time box 12 includes photos, portions of photos, and/or graphic images which visually depict the events of the timeline 10. Additionally, the timeline publishing software system 22 comprises a labeling section 28 used to create the respective label 14 for the time box 12 from the label 14 entered by category name 42. The labeling section 28 is in communication with the data entry section 24 and the time box creating section 26 in order to place the correct time box 12 underneath a corresponding label 14. The time box creating section 26 will place the time box 12 on the timeline 10 in the correct chronological location, as well as position the correct label 14 thereabove.

As previously mentioned, the time box 12 of the timeline 10 may be linked to a respective event page 16. The event page 16 is created with an event page creation section 30 of the timeline publishing software system 22. Typically the event page 16 is created by importing text, graphics, images, video, and/or audio into the software system 22. The timeline publishing software system 22 creates an event page 16 that includes content rich material such as graphics, images, text, and/or audio and video. The timeline publishing software system 22 may include templates which aid in the creation of the event page 16. The event page creation section 30 may include pre-designed event pages 16 which the user can import graphics, images, video, and/or audio into the desired format such that the event page 16 will have a professional look and feel. Furthermore, the event page creation section 30 may include pre-designed transition effects which the user may select. In this respect, the event page creation section 30 provides an interface for the user to create the event page 16 quickly and easily.

The event page creation section 30 is in communication with a linking section 32. As will be recognized, both the linking section 32, as well as the event page creation section 30, are implemented by the software of the timeline publishing software system 22. The linking section 32 links the time box 12 created with the time box creating section 26 with a corresponding event page 16 created by the event page creation section 30. The linking section 32 provides a connection or link between the time box 12 and a corresponding event page 16. As previously mentioned, a viewer of the interactive timeline 10 selects the time box 12 with the pointing device of the computer such that the event page 16 will be displayed. The linking section 32 provides the necessary connection or link between the time box 12 and the event page 16. It will be recognized that the linking section 32 can also be used to link the event page 16 to other event pages. In this respect, a viewer of an event page 16 can access other event pages by selecting items on the screen of the displayed event page 16. The viewer can therefore access multiple event pages 16 in an infinite variety of combinations.

Once the time box 12 is linked to a respective event page 16, the timeline 10 may be presented on the display 11 of the computer. It will be recognized that the timeline 10 may comprise multiple time boxes 12 linked to corresponding, multiple event pages 16. In this respect, a user will enter a starting date and a finishing date for each event that he or she wishes to create a time box 12. Additionally, the user will then create corresponding event pages 16 for each time box 12. Alternatively, it will be recognized that the user may create a time box 12 that corresponds to multiple events. In this respect, the user will first enter a starting date for a first event and a finishing date for the last event. The user will then create multiple event pages 16 that correspond to the events that happened during the period of time between the starting date and the finishing date. The event pages 16 will be created with the event page creation section 30, as previously described.

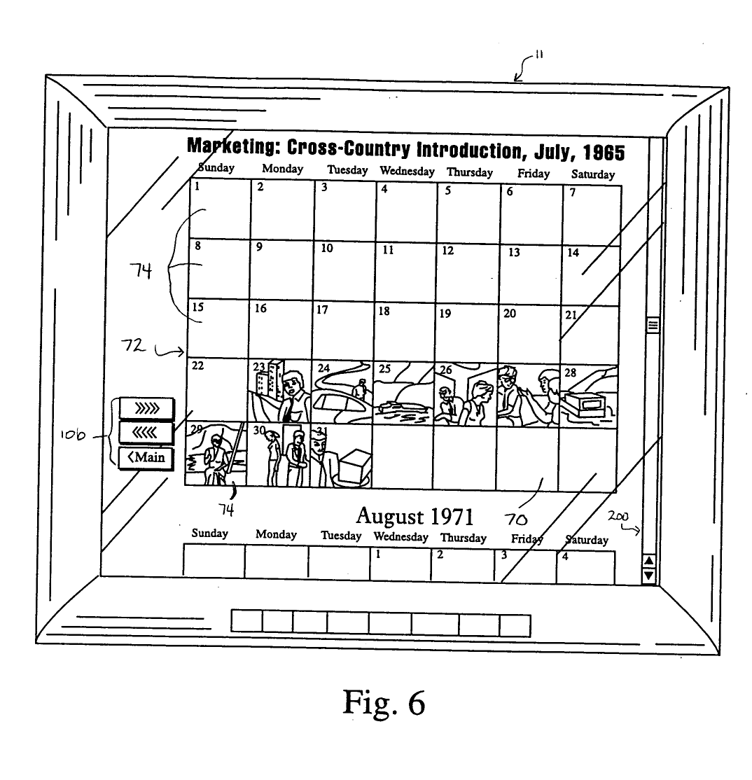

In addition to linking a time box 12 to an event page 16, the linking section 32 can also be used to link the time box 12 to a calendar page 70. Referring to FIG. 6, the calendar page 70 may illustrate the series of events which occurred over a prescribed period of time. The prescribed period of time will correspond to the length of the associated time box 12. In this respect, the start date 46 and end date 48 entered in the time box entry display 40 will determine the length of time that is displayed on the calendar page 70. The calendar page 70 will include a calendar 72 having individual days 74. The number of days 74 will correspond to the length of time between the start 46 and end date 48. The creator of the calendar page 70 will be able to import text, audio, images, video, and graphics, into each individual day 74. The information placed in each day 74 will correspond to an event that occurred on that day. Accordingly, a scrap book of images is created whereby the image shows what event occurred on the corresponding day 74. The viewer of the calendar page 70 may use his/her pointing device to click on and select an individual day 74 having an image thereon. In this respect, when the individual day 74 is selected then either a blow-up of the image may be presented on the display 11 of the computer or an event page 16 linked to the respective day 74 will be presented. The creator of the calendar page 70 can decide what type of information will be presented when the viewer of the calendar page 70 selects a respective one of the days 74.

Often times, the user will wish to edit the timeline 10. In this respect, the timeline publishing software 22 will be configured for on-screen editing by the user. The user will be able to select time boxes 12 with his or her mouse in order to change the content thereof. Any changes made to a time box 12 on the timeline 10 will be correspondingly changed in the database of information. Therefore, the timeline publishing software 22 will allow the user to edit the timeline 10 quickly and easily. It will be recognized by those of ordinary skill in the art, that it is also possible for the user to edit an event page 16 in the same manner. Alternatively, the timeline 0.10 and the event page 16 may include pull down menus (not shown) which allow the creator of the timeline 10 and event page 16 to select predetermined options as well as the usual tools common to graphics creation software for the editing and creating of the timeline 10 and event page 16.

It will be recognized that the timeline 10 creates a graphical representation of events which can be easily understood. In this respect, relationships between events can be revealed which were not apparent. Accordingly, the timeline 10 and timeline publishing software 22 may be used for multiple applications. For instance, the timeline 10 may depict the series of events in a sporting event such as a baseball game. The timeline 10 could be innings of the game. Alternatively, the segments of timeline 10 may show the teams and games for the baseball playoffs which would be a day-by-day re-cap of each game. The timeline 10 and timeline publishing software 22 could be used in the medical field to show the relationships between diseases to aid in diagnosis and treatment of patients. The legal community could use the timeline publishing software 22 to create jury presentations. Accordingly, the timeline publishing software 22 can create visual presentations of timelines 10 which can be used in education including biographies and historical events.

Additional modifications and improvements of the present invention may also be apparent to those of ordinary skill in the art. Thus, the particular combination of parts described and illustrated herein is intended to represent only a certain embodiment of the present invention, and is not intended to serve as a limitation of alternative devices within the spirit and scope of the invention.

1. A method of creating an interactive timeline with a computer, the method performed by a user interacting with software running on the computer, the method comprising the steps of:
a) entering a starting date for an event into the computer;
b) entering an ending date for the event into the computer;
c) entering information that occurred during the period of time between the starting date and the ending date for the event into the computer;
d) creating a time box with the computer, the time box corresponding to a period of time between the starting date and the ending date; and
e) linking the time box to an event page wherein the event page comprises the information entered in step (c).

2. The method of claim 1 wherein step (d) further comprises labeling the time box.

3. The method of claim 1 wherein step (d) further includes importing a photograph into the time box.

4. The method of claim 1 wherein step (e) comprises creating the event page on the computer prior to linking the time box therewith.

5. The method of claim 1 wherein step (d) comprises creating the time box so that it is displayed vertically on a screen of the computer.

6. The method of claim 1 further comprising:
(f) repeating steps (a)-(d) in order to create multiple time boxes for the interactive timeline; and
(g) linking respective time boxes to respective ones of the event pages containing information about respective events.

7. The method of claim 1 wherein step (e) comprises linking the time box to multiple event pages.

8. A method of creating an interactive timeline with a computer, the method performed by a user interacting with software running on the computer, the method comprising the steps of:
a) entering a starting date for a first event into the computer;
b) entering an ending date for a last event into the computer;
c) entering information corresponding to events that occurred during the period of time between the starting date for the first event and the ending date for the last event into the computer;
d) creating a time box with the computer, the time box corresponding to a period of time between the starting date for the first event and the ending date for the last event; and
e) linking the time box to an event page wherein the event page comprises the information entered in step (c).

9. The method of claim 8 wherein step (e) comprises creating the event page prior to linking the time box thereto.

10. The method of claim 8 further comprising:
(f) repeating steps (a)-(d) in order to create multiple time boxes for the interactive timeline; and
(g) repeating step (e) in order to link time boxes created in step (d) to respective event pages containing information about the events.

11. The method of claim 8 wherein step (e) comprises linking the time box to multiple event pages.

12. A timeline software publishing system for a computer comprising:
a data entry section that receives a starting date and an ending date for an event from a user;
a time box creating section that creates a time box using information corresponding to the event the information received from the user the time box displayable on the computer, the time box corresponding to a period of time between the starting date and the ending date; and
a linking section that links the time box to an event page, the event page comprising the information corresponding to the event.

13. The timeline publishing system of claim 12 further comprising an event page creation section operative to create the event page prior to linking the time box to the event page.

14. The timeline publishing system of claim 12 wherein:
the data entry section further receives respective starting dates and respective ending dates for multiple events;
the time box creating section further creates time boxes corresponding to respective ones of the multiple events; and
the linking section further links the time boxes to respective ones of the event pages comprising information corresponding to the events.

15. The timeline publishing system of claim 12 further comprising a labeling section operative to create a label for the time box.

16. The timeline publishing system of claim 12 wherein the time box creating section creates the time box so that it is displayed vertically on a screen of the computer.
